(19) United States
(12) Patent Application Publication
(10) Pub. No.: US 2023/0163276 A1
(43) Pub. Date: May 25, 2023

(54) Electrode with lattice structure

(71) Applicant: Bobby Singh Poonia, Leicester (GB)

(72) Inventor: Bobby Singh Poonia, Leicester (GB)

(21) Appl. No.: 17/889,594

(22) PCT Filed: Feb. 18, 2021
(86) PCT No.: PCT/GB2021/050403

§ 371 Date: Aug. 17, 2022

(51) Int. Cl. H01M 4/36; H01M 4/04; H01M 4/587; H01M 4/60; H01M 10/42

(52) U.S. Cl. CPC H01M 4/366; H01M 4/045; H01M 4/0471; H01M 4/587; H01M 4/602; H01M 10/4214; H01M 10/4242; H01M 2004/021

(57) ABSTRACT

The present invention relates to a flow battery system. The system comprises a first and second electrode comprising a lattice structure and at least one electrolyte supply configured to provide flow electrolyte through at least one of the first and second electrodes. A power circuit is operatively connected to the first and second electrodes to provide electrical power from the system.

### CROSS-REFERENCE DATA

The present application is a national stage of the International Application No. PCT/GB2021/050403 with the same title, which in turn claims a priority date benefit from the UK Patent application No. GB 2002221.6 filed 18 Feb. 2020, incorporated herein by reference.

The present invention relates to an electrode structure, particularly to an electrode structure for a flow cell battery.

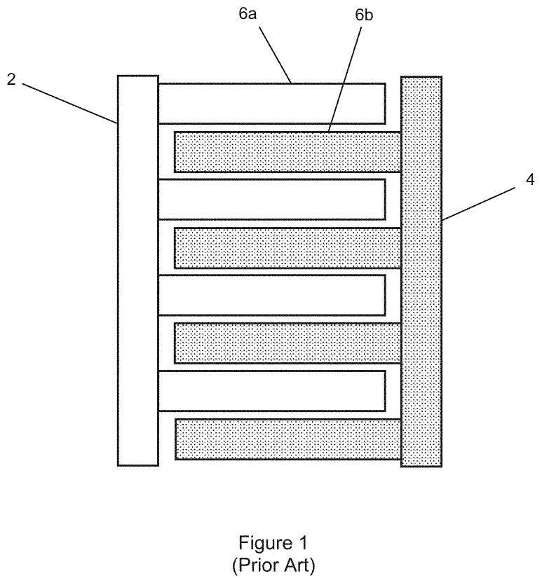

In conventional electrodes for batteries or the like, the anode and the cathode comprise an “interdigitated geometry”. As shown in FIG. 1, the cathode 2 and the anode 4 have a plurality of respective fingers 6. The fingers 6 are interleaved, such that such each cathode finger 6a is interposed between adjacent anode fingers 6b, and vice versa, to create an alternating pattern of anodes and cathodes. The cathode and anode fingers may be separated by an ion separator (not shown), such as a membrane, to selectively permit the transfer of ions/electrons between the electrodes. The electrolyte then flows between the fingers 6 to carry charge.

The inventor has found, however, that the interdigitated geometry constricts the flow of electrolyte through and/or between the electrodes. This, in turn, reduces the electron generation of the cell, thus reducing the electrical power thereof. Additionally, this may reduce the storage capacity of battery, as only part of the electrode may be accessible by the electrolyte, thereby preventing the power generating redox reactions from occurring at these portions of the electrode.

It is an aim of the present invention to overcome or ameliorate one or more of the above problems. It may be considered an additional or alternative aim to provide a battery that offers high energy density and/or prolonged use.

According to a first aspect of the invention, there is provided a flow battery as defined in claim 1. Optional features are defined in the dependent claims.

According to a second aspect of the invention, there is provided an electrode for an electrochemical cell, the electrode comprising a three-dimensional lattice structure having a network of interconnecting limbs, wherein each limb intersects with a plurality of further limbs extending in different directions, the lattice structure configured to be at least partially immersed in an electrolyte in use.

The lattice structure may comprise one or more of: a body-centre; a face centre; an octet-truss; a primitive; or a diamond-based unit cell.

The lattice structure may comprise a minimal surface type structure. The lattice structure may comprise a Triply Periodic Minimal Surface type structure.

The lattice structure may comprise a gyroid structure.

The limbs may comprise a cross-sectional profile that varies along their length.

The limbs may be hollow.

The limbs may be arched or curvate. The limbs may comprise wall members. The wall members may be arched in cross-section so as to define concave and convex surfaces on opposing sides thereof.

The lattice structure may comprise a sheet-like structure.

The limbs may comprise strut-like members. The limbs may be solid (i.e. not hollow).

The lattice structure may comprise a skeletal type structure.

The lattice structure may be conductive. The lattice structure may comprise a conductive polymer. The conductive polymer may comprise a polymer impregnated and/or coated with a conductive material. The conductive material may comprise graphene or graphite.

The lattice structure may comprise a coating. The coating may be conductive. The coating may comprisesa metal and/or metallic oxide. The coating may comprise a functional electrochemical component. The coating may comprise one or more: Lithium; Magnesium; Lead, Nickel; and/or oxides thereof. Preferably, coating is applied to the lattice via electroplating.

The lattice structure may be manufactured using a 3D printing technique. The 3D printing technique may comprise one or more of: stereolithography; fused filament fabrication; or selective laser sintering.

The lattice structure may be printed using a printed head comprising a variable shape/size aperture.

According to a third aspect of the invention, there is provided: a flow battery system comprising: a first and second electrode; at least one electrolyte supply configured to provide flow electrolyte through at least one of the first and second electrodes; and a power circuit operatively connected to the first and second electrodes to provide electrical power from the system.

The electrode is typically porous, e.g. taking the form of a lattice structure.

At least one of the first and second electrode may comprise a substantially planar panel or sheet.

At least one of the first and second electrode may be provided in a housing, the housing comprising a plurality of the at least one of the first and second electrode.

The first and second electrode may be provided in respective housings, each of the housings fluidly connected to the electrolyte supply, such that the same electrolyte is passed through both the first and second electrodes.

At least one of the first and second electrode may be provided in a pressurised housing.

The panels may be spaced about a direction perpendicular to the plane of the panel.

The panels may be perpendicular to the flow the electrolyte.

The flow battery may comprise at least one anolyte supply, at least one catholyte supply, the anolyte supply and the catholyte supply fluidly connected to respective electrodes and configured to provide flow of anolyte and catholyte through the respective electrodes; and an ion separator operatively interposed the electrodes.

The ion may separator comprise an ion selective membrane.

According to a fourth aspect of the invention, there is provided a method manufacturing an electrode, comprising: providing a first porous sheet; overlaying the first sheet with a second porous sheet; bonding the first sheet to the second sheet at one or more discrete location; and deforming one or both of the sheets to provide a 3-dimensional structure.

The sheet may be perforated and/or comprise cut-outs. The 3-dimensional structure may comprise a 3-dimensional network of pores/channels.

The method may comprise separating the first and second sheet to cause deformation of the first and/or second sheet after bonding of the first and second sheet (e.g. to provide an expanded electrode).

The method may comprise deforming the first and/or second sheet prior to bonding of the first and second sheet.

The sheets may be bonded by one or more of: welding; adhesives; soldering; stapling; riveting; staking. The sheets may be bonded using a brazing technique. The brazing technique may comprise sinter brazing.

The sheets may comprise discontinuities or apertures therein, e.g. a two-dimensional array of apertures. The apertures may be spaced over the sheet, e.g. according to a repeating pattern.

Any optional features defined in relation to any one aspect may be applied to any further aspect of the invention, wherever practicable.

Workable embodiments of the invention are described in further detail below by way of example only with reference to the accompanying drawings, of which:

FIG. 1 shows a conventional electrode arrangement in a battery or the like;

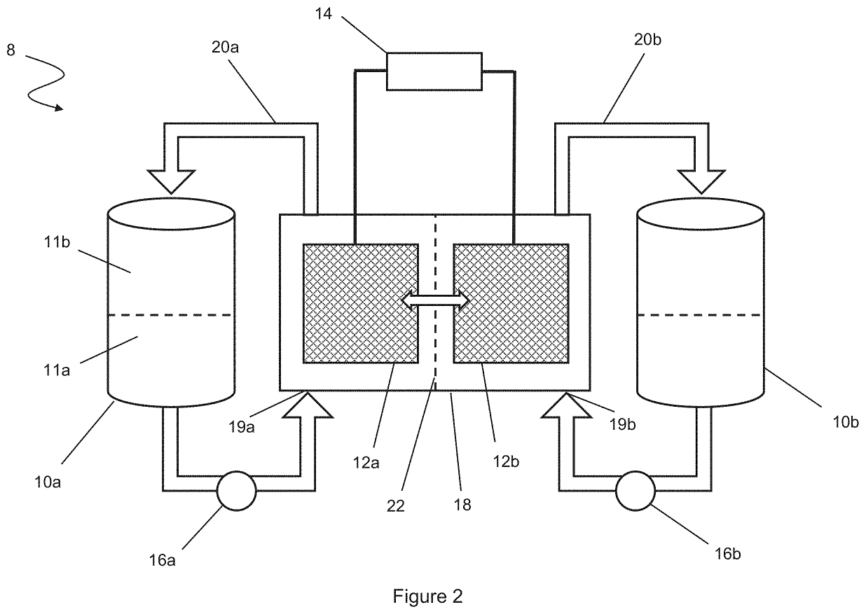

FIG. 2 shows a schematic view of a first flow battery arrangement comprising a lattice-based electrode;

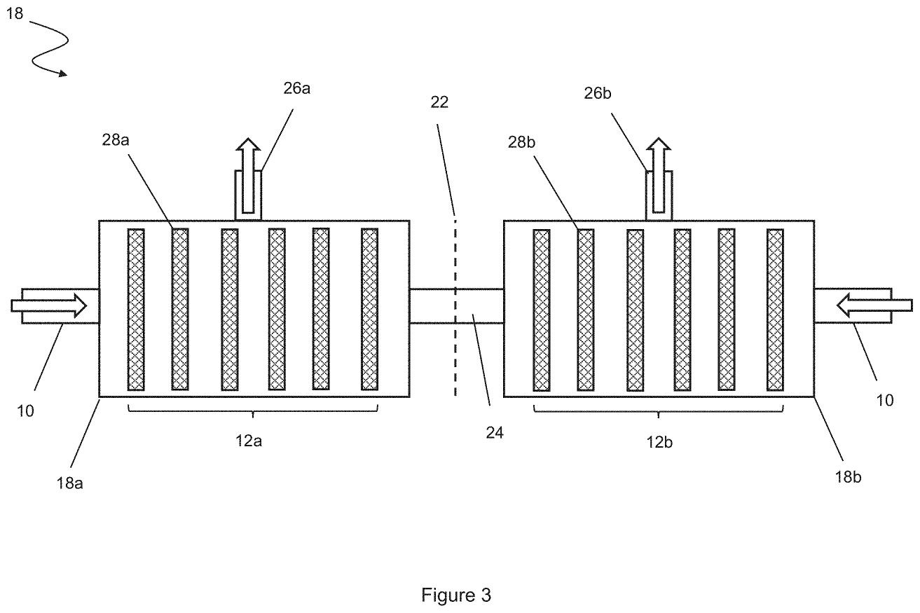

FIG. 3 shows a schematic view of a second flow battery arrangement comprising a lattice-based electrode;

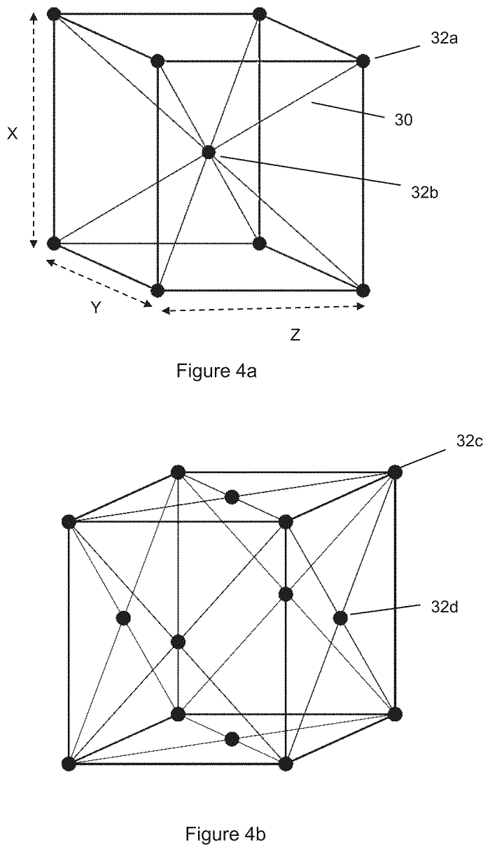

FIGS. 4a and 4b show examples of a strut-type unit cell of the lattice;

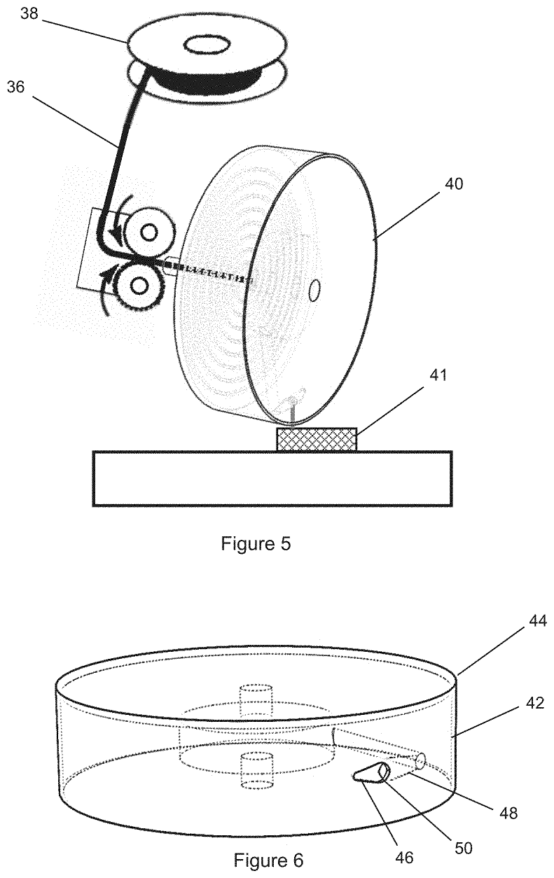

FIG. 5 shows a schematic view of a 3D printing arrangement suitable for printing the lattice;

FIG. 6 shows a close-up view of a printer head of the 3D printing arrangement;

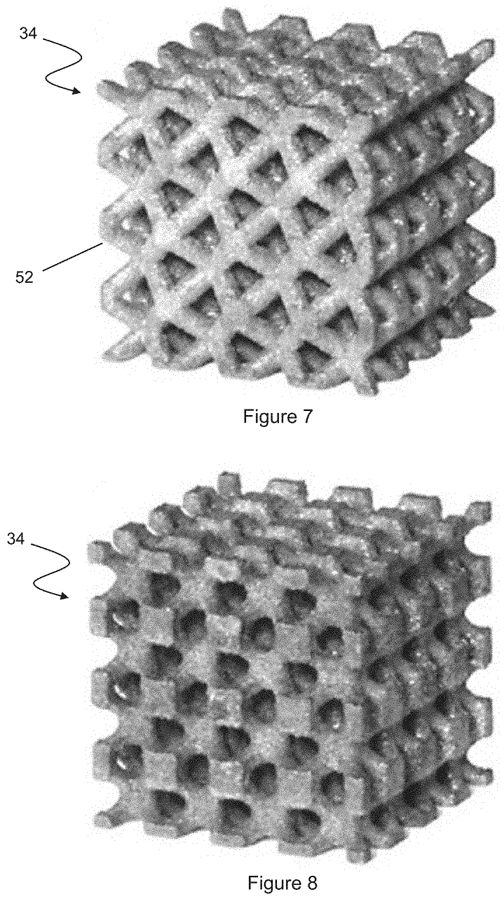

FIGS. 7 and 8 show a coating on example the lattice structures;

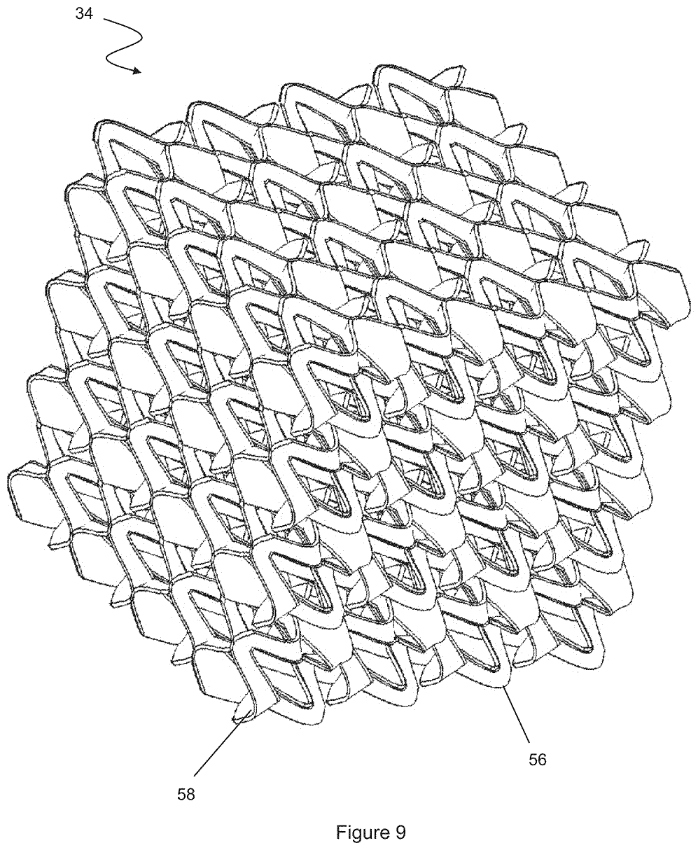

FIGS. 9-11 shows a further embodiment of the lattice structure;

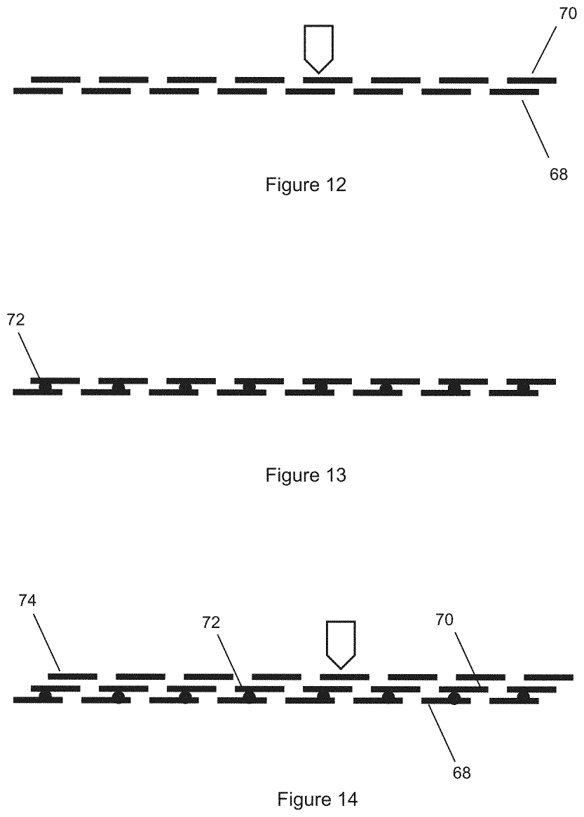

FIGS. 12-16 shows a first method of manufacturing the lattice structure;

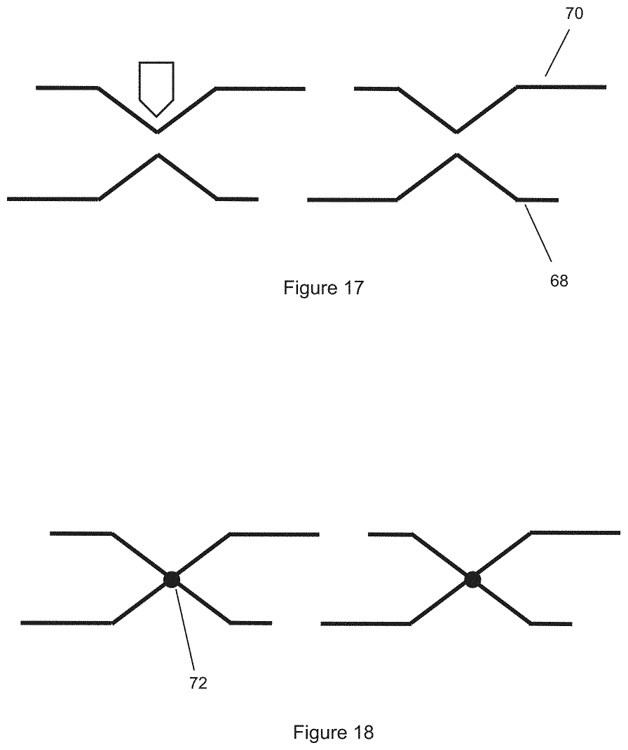

FIGS. 17 and 18 show a second method of manufacturing the lattice structure;

FIG. 2 shows a flow battery/electrochemical cell arrangement, generally indicated at 8. The flow battery/cell comprises a first electrolyte supply 10a. The first electrolyte supply is fluidly connected to a first electrode 12a, such that an electrolyte is passed through the electrode in use. The electrolyte comprises a “charged” electrolyte whereby the energy for the electrochemical reaction in use is stored in the electrolyte.

The electrolyte interacts with the electrode 12a thus changing the oxidation state of the electrolyte, as is conventional in a flow battery. The electrolyte thus passes through the electrode and is “discharged”. The electrode 12a is operatively connected to a power circuit 14, thereby allowing electrical power to be extracted from the system.

The electrolyte may be pumped using a pump 16a. In other embodiments, the electrolyte may be moved through the system by other means, for example, under the action of gravity.

The flow rate of electrolyte is determined according to the power output power requirement. The system comprises a flow management system which can vary the flow of electrolyte according to power demand. A suitable controller (not shown) may control the flow rate according to one or more received signal input, such as a power demand signal or sensor signal. The flow rate of electrolyte may be varied for example by varying the power to pump 16a (i.e. the speed of the pump) and/or controlling a flow regulator/valve, such as by adjusting a variable-area flow valve or the like.

The housing 18 has an inlet 19a for receiving a flow of electrolyte.

The electrode 12a is contained within a housing 18 (i.e. an enclosure). The housing substantially seals the electrode 12a therein, bar any electrolyte flow openings, such that any electrolyte passing therethrough is contained.

The housing 18 may be pressurized.

The housing interior containing the electrode 12a is fluidly connected to a drain 20a (i.e. an outlet of the housing) to remove the discharged electrolyte once it has passed through the electrode 12a. The inlet 19a may be spaced from the outlet 20a by the electrode 12a, e.g. being on opposing sides of the housing 18. Alternatively, a flow regime, e.g. a circulatory flow in the housing, may be established that does not require the inlet 19a and outlet 20a to be opposing whilst still causing flow through the electrode 12a.

Thus, the electrolyte can continually pass through the electrode 12a in a flow path from the inlet 19a to the outlet 20a.

The electrolyte supply 10a comprises a tank or the like configured to store the charged electrolyte. A second tank may be provided to store the discharged electrolyte which has passed through the electrode 12a. The second tank may form part of first tank (i.e. the tank has a partition to segregate the electrolytes). The tank may be divided into compartments 11a, and 11b for the charged and discharged electrolytes respectively. Each is compartment is fluidly separate or distinct. Each compartment 11 may be operatively connected to a pump 16 to allow filling/emptying thereof. In other embodiments, the second tank is separate/spaced from the charge electrolyte tank.

Each compartment may have respective inlets/outlets to allow filling/emptying thereof from an external source. A first valve is provided to open/close the inlet to the discharged electrolyte tank and a second valve is provided to open/close the outlet to the discharged electrolyte tank. In normal operation, the first valve is open and the second valve is closed.

During the emptying of the discharged electrolyte tank, the first valve is closed and the second valve is open. A similar arrangement is provided for the charged electrolyte tank.

Alternatively, the electrolyte may be continually pumped through the tank, such that any discharged electrolyte is mixed with the charged electrolyte. The electrolyte mixture is then re-circulated.

The electrolyte supply 10a and the associated flow through the electrode 12a provides a first electrolyte circuit.

A second electrolyte circuit is provided by a second electrode 12b and a second electrolyte supply 10b. Like features of the first and second circuit will not be repeated for the sake of brevity. In use, the first electrolyte circuit will comprise an anolyte, and the second electrolyte circuit will comprise a catholyte, or vice versa.

The first electrode 12a and the second electrode 12b are contained within the housing 18. The housing 18 is a common housing for the first 12a and second 12b electrodes. However, the housing comprises a partition 22 such that each electrode, 12a and 12b is retained in its respective electrolyte circuit, i.e. within a flow of anolyte or catholyte. The first electrode 12a and the second electrode 12b are thus fluidly segregated by the partition 22.

The partition 22 takes the form of an ion separator 22 operatively interposed between the first and second electrode. The ion separator 22 partitions the housing 18 in a mechanical/fluidic sense. The ion separator 22 is configured to permit select ions therethrough, thereby allowing ion transfer 24 between the electrodes 12a,12b. The partition 22 comprises a membrane or similar thin-walled structure.

The difference in oxidation potential of the anolyte and catholyte as they pass through the respective electrodes 12a,12b provides electrical energy to the power source 14. Such a process is conventional and will be understood by the person skilled in the art. The process is reversible, thus allowing the system to be recharged.

Whilst the electrode structures 12a and 12b are shown as being separate, they could be conjoined in other examples, provided a partition 22 can be provided to segregate the electrolyte flow through the electrode lattice on either side thereof.

The charged electrolyte may be input into the tank from an external source. The discharged electrolyte may be removed from the tank to an external source. Thus the charged/high-energy electrolyte can be used as a consumable, which is replaced when required. This mitigates the need to recharge the battery, which may be time-consuming, and “recharge” time is only limited by the rate in which the tank can be filled with electrolyte.

The discharged/low-energy electrolyte may be re-processed offsite to provide charged electrolyte. Re-processing may be provided by running an electrochemical cell in reverse (i.e. by providing electrical power to the power circuit) to recharge the electrolyte. Alternatively, the electrochemical cell 8 of the present invention may be run in reverse to recharge the electrolyte in situ. Any suitable method of re-processing the discharged electrolyte may be accommodated.

The housing 18 is shown in detail in in FIG. 3. The first electrode 12a is housed within a first housing portion 18a and a second electrode is housed in a second housing portion 18b. The housings 18a,18b are separated by the partition 22. The electrolytes flows from the electrolyte supply, into the respective housings 12a,b and out through respective outlets 26a,b.

The housings 12a, 12b may be pressurised. This may ensure greater interaction between the electrolyte and the electrodes 12a, 12b. The pressure may be greater than or equal to 2 bar; preferably, greater than or equal to 5 bar.

The electrodes 12a, 12b are operatively connected to respective terminals configured to connect to the power circuit 14 in use.

The electrodes 12a, 12b, comprises a plurality of discrete electrodes. The electrodes comprise substantially planar panels 28a, 28a. The panels 28a, 28a span the width of the housing, therefore spanning the flow of the electrolyte. The planar face of the panels 28a, 28a are provided perpendicularly to electrolyte flow (i.e. face onto the flow). The panels 28a, 28a are spaced apart. This ensures adequate flow.

The panels 28a and 28b are selectively removable from the housing 18. This allows replacement thereof, when the system is run in a discharge cycle only. The panels 28a and 28b may be retained via a release mechanism. The panels 28a and 28b, may be individually removable. In some embodiments, the panels 28a and 28b may be mounted to a backing structure to allow removal of the panels 28a and 28b, in a respective housing portion 18a and 18b.

In some embodiments, the electrodes 12a, 12b comprise a material configured to oxidise/reduce to provide the electrochemical energy. The electrolyte thus facilitates the transfer of ions between the electrodes, similar to a conventional battery. An ion separator is therefore not required to operatively separate the electrodes and such technologies may be referred to as “membraneless” flow batteries/cells. For example, one electrode may comprise Lead and the other electrode may comprise Lead Oxide. The electrolyte may comprise methanesulfonic acid. In other embodiments, the electrodes may comprise Copper/Lead Oxide; Zinc/Nickel; Zinc/Manganese Oxide.

In use, oxidation of the electrode metal during discharge of the battery may lead to undesirable build-up of oxide (i.e. on the anode). The system may therefore be run in a charge cycle (i.e. providing to the power circuit 20), thereby reducing the oxides by reduction thereof back to the metallic state. Additionally, or alternatively, this may reverse the transfer of metals/metal oxides deposited on the electrodes during the discharge cycle, thus restoring the electrodes to a charged state.

A plurality of respective electrodes 12 may connected in a series/parallel arrangement to increase the output power as per requirement of the application.

Sacrificial anodes may be provided in the system to prevent excessive oxidation of the electrodes 12. The sacrificial anode may be replaced once depleted. The anodes may be replaced periodically (e.g. when depleted or below a certain efficacy).

The electrodes 12 of any of the embodiments described herein comprise a lattice structure. The lattice structure comprises a three-dimensional structure, such that the lattice forms a network of interconnecting elements. The elements intersect a plurality of further elements extending in different directions. The lattice structure thus provides a three-dimensional framework, with open space between the elements of the framework. This permits the electrolyte to flow through the lattice structure (i.e. between or around each of the elements). The electrode 12 is thus substantially porous.

The lattice structure comprises a plurality of repeating cells, typically referred to as “unit cells”. The unit cells define the specific geometry of the lattice structure.

As shown in FIGS. 4a and 4b, the lattice structure may comprise a “strut-type” structure. The strut-type structure comprises a plurality of limbs 30 extending between respective nodes 32 in the lattice.

In FIG. 4a, the nodes are arranged in a body centre cubic (BCC) geometry, thus defining a BCC unit cell. A BCC unit cell comprises a corner node 32a at each of the corners of a cubic cell, with a further node 32b provided in the centre of the cubic cell. A limb 30 is provided between each nearest neighbour in the unit cell. Thus, a limb 30 is provided between each of the respective corner nodes 32a and the centre node 32b. This results in eight limbs depending from the central node 32b of the unit cell.

Alternatively, in a simple grid-like lattice structure with nodes at grid intersections, six limbs would depend from each node along each orthogonal direction.

FIG. 4b shows a similar structure using a face centre cubic (FCC) unit cell. A limb 30 is defined between each corner node 32c and an adjacent face centre node 32d.

It can be appreciated that such a construction be used to provide a strut-type lattice for any number of unit cells. For example, the lattice may comprise: an octet-truss; a diamond; a kelvin; hexagonal; gyroid; or primitive cubic unit cell.

The limbs 30 may be solid. Alternatively, the limbs 30 may be hollow or porous, thereby saving material and/or providing greater flow of electrolyte. The limbs may be substantially circular in cross-section.

The lattice structure may comprise a “minimal surface” type structure. A minimal surface represents a surface which extends between nodes of the lattice structure, and minimises the local surface area thereof. Such minimal surfaces can be observed in practise, for example, by creating a liquid bubble between the nodes. The bubble attempts to reduce the bubble/air interface, thus adopting a “minimal surface”.

The minimal surfaces comprise triply period minimal surfaces (TPMS). This means that the surface is substantially continuous across adjacent unit cells, thus providing a continuous surface extending through the lattice. Such minimal surfaces may be obtained computationally or derived from known surfaces, as will be understood by those skilled in the art.

The minimal surface is thickened and/or volume solidified (i.e. hollow areas are filled between the minimal surfaces). This provides a “skeletal”-type lattice structure.

In a first embodiment using a skeletal type BCC unit cell, The limbs 30 are curvate. The inventor has found that the curved nature of limbs 30 increase the structural strength of the lattice, due to a reduction in stress concentrations at sharp corners. Additionally or alternatively, this provides smoother fluid flow as less turbulence is caused as the electrolyte passes through the lattice. The surface of the structure may be described as continuous, e.g. avoiding the presence of any discontinuities, sharp corners/edges or acute angles. All nodes/limbs may be rounded or curved in profile.

The lattice may comprise a skeletal type diamond unit cell and or a skeletal type gyroid unit cell. It can be appreciated that these are merely examples of skeletal type structures, and any skeletal type structure of a previously discussed unit cell or other conventional unit cell may be provided.

In some embodiments, the minimal surface remains substantially un-thickened (i.e. only thickened to the extent required to support the lattice). This provides a “sheet”-type lattice structure.

In some embodiments, the lattice comprises a surface for a BCC unit cell. Such a surface may be referred to as a Schoen IWP. The nodes and the area within the surface are substantially hollow. The limbs are therefore hollow. Such an arrangement therefore allows a further flow of electrolyte through the lattice.

In some embodiments, the lattice comprises a sheet type diamond unit cell or a sheet type gyroid unit cell. The inventor has found that the gyroid structure provides an optimum strength for a given weight and given amount of material. Again, it can be appreciated that the sheet type may be based on any unit cell, including those previously discussed. The minimal surface may comprise Schwarz, Neovius, Schoen, or Fischer-Koch minimal surfaces.

In the present embodiment, the unit cell is cubic (side lengths X=Y=Z), however, it can be appreciated that the unit cells may be tetragonal (e.g. X≠Y=Z) or tetragonal (X≠Y≠Z). Additionally or alternatively, the corner nodes may not be provided at right angles, for example, to provide a triclinic, monoclinic, hexagonal, or rhombohedral unit cell.

In some embodiments, the lattice may not comprise conventional or repeating unit cells. For example, the lattice structure may be random (i.e. comprises randomly spaced/orientated limbs 30). Alternatively, the lattice may comprise mixture of different type unit cells and/or comprises a different size or orientation of unit cells.

It can be seen that the lattice comprises numerous passages for the electrolyte to pass through. Additionally, the lattice greatly increases the surface area available for the electrolyte to make contact with. For example, a BCC structure comprises approximately 60 times the surface area of a solid cube of the same volume/mass. This allows greater interaction of the electrolyte and the electrode 12, thereby increasing the amount of charge the electrode 12 may generate. This, in turn, allows greater power to be provided by the battery.

In one example, a BCC structure with a 5 mm cubic unit cell and a 20 mm³ lattice structure has approximately 4500 mm² surface area. Similarly, at micro scale, the lattice structure surface area (depending on the size and the type of lattice structure used) can exponentially increase the surface area compared to a solid body, which leads to the higher energy densities in a compact space.

The unit cell may be greater than or equal to 0.1 mm; preferably, greater than or equal to 1 mm. The unit cell may be between 0.1 and 10 mm. The lattice (i.e. the electrode) may be greater than or equal to 10 mm; preferably, greater than or equal to 100 mm. The lattice may be between 10 mm and 1500 mm. Generally speaking, high powered devices such as home or commercial systems will comprise a larger lattice size, for example, between 1000 mm and 1500 mm. Lower powered devices, such as cars trucks, boats etc, will have a smaller lattice size, for example, between 400 mm and 1000 mm. However, it can be appreciated these are merely examples, and the lattice may comprise any size required, depending on the specific application.

The lattices shown are substantially cuboid, however, it can be appreciated that the lattices may be any shape as required. For example, the lattice 34 may be cylindrical.

The lattice 34 comprises a conductive material. The lattice 34/electrode 12 can therefore transport electrons generated by the electrochemical process in the battery/fuel cell to the power circuit 20.

The lattice material comprises 3D printable material. For example, the material is suitable for melting and re-solidification without detriment to the functional properties thereof. Typically, the lattice comprises a polymer.

In some embodiments, the lattice comprises a conductive polymer. The polymer may be an intrinsically conductive or semi-conductive polymer. Additionally or alternatively, the polymer may be doped, coated or otherwise impregnated with a conductive material. The conductive material may comprise a conductive carbon based material. The conductive material may comprise one or more of: graphene; graphite; carbon black; carbon fibre; carbon nanotubes; or a metal (e.g. metal nano-particles).

The polymer may comprise one or more of: polyactic acid (PLA); acrylonitrile butadiene styrene (ABS); acrylonitrile styrene acrylate (ASA); polyethylene terephthalate (PET); polycarbonate High Performance Polymers (HPP), such as PEEK, PEKK or ULTEM; flexible polymers, such as TPE or TPU; polyamides; polyamides and aluminium mixture; or other conventional materials. The polymer may comprise recycled material

In a specific embodiment, the conductive polymer comprises PLA doped with graphene.

The use of a polymer material reduces the risk of corrosion or contamination due to the dissolution of the lattice in the electrolyte. The polymer also provides structural rigidity.

In other embodiments, the lattice comprises a metallic material. The metallic material chosen will be appropriate to the electrolyte used in the system (i.e. to prevent corrosion thereof).

The lattice 34 is manufactured using additive layer manufacturing (i.e. 3D printing). The exact manufacturing technique may be dependent on the size of the lattice 34/unit cell thereof.

For example, for small scale unit cells or lattices, a stereolithography (SLA) technique may be used. In this technique, the laser scans across a photopolymer resin, thus selectively curing the polymer. This permits high accuracy modelling on a small scale. The SLA technique may use LCD masking or Digital Light Processing to permit a whole layer to be completed at a single time.

Alternatively, particularly for larger unit cells, a fused filament fabrication (FFF) technique may be used (commonly referred to fused deposition modelling). Such an arrangement is shown in FIG. 8. In this technique, a continuous filament of a thermoplastic material 36 is fed from a reel 38 through a moving, heated printer extruder head 40 (shown in exaggerated proportions), and is deposited on the workpiece 41 (i.e. the lattice 34 in this example).

According to a specific embodiment shown in FIGS. 5 and 6, the printer head 40 comprises a cover shell 42, and a body 44. The printer head is cylindrical (i.e. puck-like in form). The cover shell 42 is hollow and rotatably receives the body 44 therein. The body 44 is held within the shell 42 in a close-fitting arrangement, i.e. so that the body side wall is immediately adjacent the shell side wall.

The cover shell 42 comprises an aperture 46 in the side wall thereof, and the body 44 comprises an aperture 48 in the corresponding side wall thereof. Where the apertures 46, 48 overlap there is an outlet through which material may be extruded, herein referred to as the deposition outlet 50.

The cover shell 42 is rotatable relative to the body 44 so as to selectively vary the degree of overlap of the respective apertures 46, 48. This in turn varies the open/exposed area of the deposition outlet 50, thus varying the density/thickness of material deposited through the deposition outlet 6 in use. The printer head 40 is described in further detail in the applicant's co-pending application GB1919303.6, which is incorporated herein by reference.

Such an arrangement allows the printer to easily printer the different thickness or sizes of limbs 30 in the lattice without requiring separate nozzles etc.

Where the lattice comprises a metallic material, the 3D printing process may comprise a more suitable technique, such a Selective Laser Sintering (SLS) or Selective Laser Metaling (SLM).

The lattice 34 may then be coated with a coating. The coating may protect the lattice 34 from corrosion or abrasion from the electrolyte. Additionally or alternatively, the coating provides or enhances of the conductivity of the lattice. The coating may comprise a conductive material, such as metal or graphene/graphite.

In some embodiments. the coating may form a functional part of the electrochemical cell (i.e. the coating undergoes oxidation/reduction as part of the electrochemical process). The coating comprises a metal and/or the oxide thereof. For example, the coating may comprise one or more of: Lithium; Magnesium; Lead, Nickel; Zinc; and/or oxides thereof. Other materials may be present depending on the specific chemistry involved.

Examples of a lattice 34 comprising a coating 52 is shown in FIGS. 7 and 8. The coating 52 covers substantially the entire surface of the limbs 30. Substantially the entire surface of the lattice 34 is therefore functionally available. However, the coating 52 is of a thickness such that the gaps or hollows in the lattice 34 are not obscured, thus ensuring adequate flow through the lattice 34. Thus, the coated lattice retains an effective lattice structure (i.e. the lattice 34 is not transformed into a “solid” block).

The coating 52 may have a thickness between 2% and 20% the size of the unit. For example, the coating may have a thickness of between 0.01 mm and 2 mm, depending on the size of the lattice used and the power required to be stored by the system. However, it can be appreciated that the thickness of the coating varies as the system is charged/discharged.

The coating 52 is applied to the lattice 34 using electrodeposition. This may be achieved by electroplating. The specific electroplating process will be understood by the person skilled in the art and will not be described further.

In the event of degradation of the coating during use, the lattice coating 52 can be re-generated using the same technique.

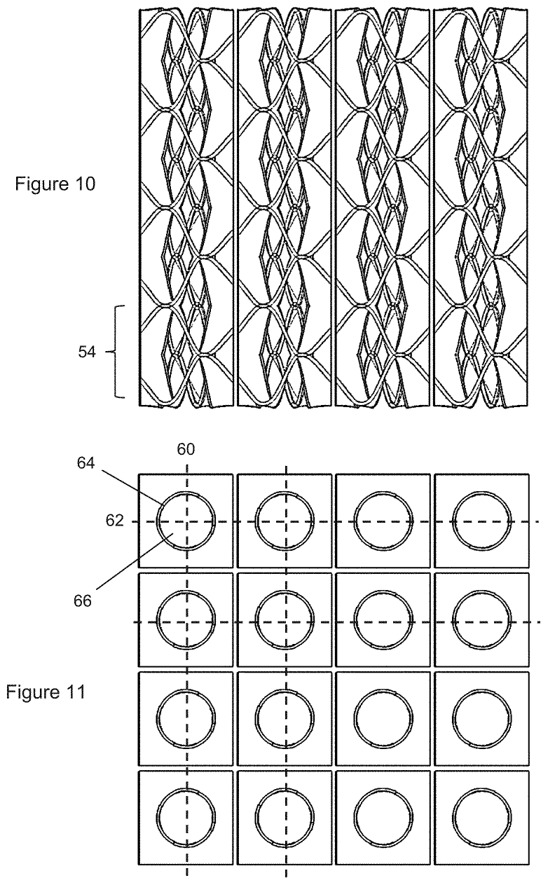

A further embodiment of the lattice structure is shown in FIGS. 9-11. The lattice structure is formed from a number of layers 54. Each layer 54 comprises a first waveform 56. The waveform 56 comprises an undulating, oscillating, or sinusoidal-like waveform. The waveform 56 repeats across the surface of the layer. A second, similar waveform 58 is provided at right angles to the first waveform. As shown in FIGS. 10 and 11, the peak/troughs 60, 62 of the first and second waveforms respectively define a grid-like arrangement. Each unit cell comprises a single instance of the first and second waveform (e.g. a single peak/trough of each waveform).

An area 64 surrounding the intersection of the waveforms is absent. This provides an aperture or channel 66 extending through the layer.

The layer structure is repeated any number of times to define the lattice 34. The channel 66 is continuous through each layer, thus defining a channel 66 through the complete lattice. In the present embodiment, the layers 54 are provided in a repeating pattern, to provide a self-similar structure. In other embodiments, one or more layers 54 may be offset and/or rotated with respect to one another.

The lattice may be manufactured using a sheet process, e.g. by processing an initially-flat sheet material. The process may comprise deforming the sheet material and/or joining adjacent sheets at discreet locations.

An example process is described in detail with reference to FIGS. 12-16. A sheet 68 is first perforated according to a desired pattern. As shown in FIG. 12, a second perforated sheet 70 is then overlaid the first sheet. The sheets are substantially flat/planar. Regular/repeating patterns of perforations may be provided over the surface area of the sheet.

The first 68 and second 70 sheets are then bonded at suitable points. In the present example, the sheets are bonded using a welding technique (i.e. spot welding). However, any suitable technique may be used, for example: adhesive; soldering; stapling; riveting; staking etc. In some embodiments, the layers may be bonded using a brazing technique. The brazing technique may comprise sinter brazing. This provides an effective way to form a plurality of simultaneous bonds and/or provide bonds in other where access may be difficult with a welding tool.

Referring to FIG. 13, the bonding process is repeated/performed at spaced locations along the length and width of the sheet (i.e. in 2D plane). A plurality of joints 72 are therefore provided over the major surface area of the sheets.

Referring to FIG. 14, the process may be repeated with a further layer 74.

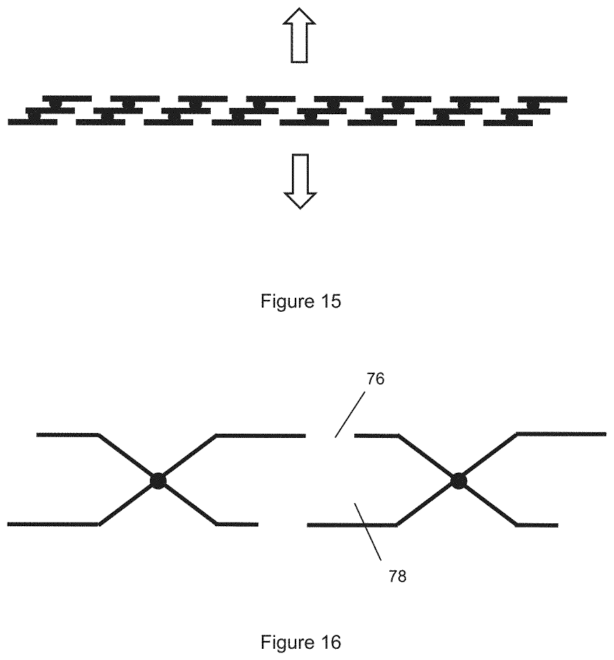

In the next step, shown in FIG. 15, the layers 68, 70, 74 are pulled apart perpendicular to the plane thereof. As shown in FIG. 16, this causes the layers to deform to provide a 3D structure. The lattice thus comprises an expanded structure. The perforations 76 and space 78 between the sheets provide a 3D network of channels. The structure is therefore porous and comprises a high surface area.

In the present embodiment, each layer is shown as offset from one another. Thus, the joints are offset in each layer. However, such an offset may not be provided in other embodiments. The perforations 76 in the adjacent layers may be aligned or offset accordingly.

In a second embodiment shown in FIG. 17, the sheets are deformed/shaped before bonding of the sheets 68, 70. This allows formation of complex and/or precise shapes not achievable by deformation of the layer subsequent to bonding. The sheet material could be pressed or otherwise deformed using a conventional shaping process, e.g. passing the sheet through rollers or the like, to achieve the desired form.

The sheets are then bonded as previously described at the desired points, and any number of layers may be constructed. The final product is shown in FIG. 18. It can be seen that such a technique arrives at a similar result to that shown in FIG. 16, although the different methods may be better suited to achieve different three-dimensional structures.

The lattice may then be coated and or shaped for use in the flow battery as previously described. In some embodiments, the lattice may be manufactured using a 3D printing technique.

The use of sheet-based method may be suitable for assembled large-scale lattices, for example those of the scale of 1 m or larger. This technique provides a cost-effective and scalable method of creating complex lattices. Any number of complex designs or patterns can be created.

Although the present invention is described in terms of a flow battery, it can be appreciated that the described electrode can be used in any electrochemical cell (e.g. battery, flow battery, or fuel cell) where high electrode surface area is desirable. This may comprise conventional batteries, fuel cells, or hybrid cells. The electrode may be used in any electrochemical cell requiring interaction with a solid, liquid, or gaseous electrolyte (e.g. hybrid flow cells). The aforementioned lattices are merely exemplary and any suitable porous structure may be used.

The present invention provides an electrode with an increased surface for a given weight or volume. This increases the power output and/or storage capacity (i.e. energy density) of the electrochemical cell.

The lattice structure increases the flow of electrolyte through the electrochemical cell. This may be particularly beneficial in a flow battery, where electron generation is dependent on the flow of electrolyte.

The lattice structure provides a porous electrode, without significantly affecting the structural properties of the electrode. The minimal surface structure reduces the stress concentrations in the electrode, thereby reducing the chance of cracking etc.

The lattice, lattice coating and/or electrolyte provide a rechargeable battery/fuel cell system.

The electrode can be manufactured in an autonomous and fast fashion using standard 3D printing equipment. The electrode is made from widely available materials and may be easily recycled or refurbished. For example, the electrode comprises PET, which may be recycled from/into plastic drinks bottle.

The flow battery arrangements disclosed herein allow emptying and refilling of electrolyte in a manner that is more akin to refuelling. Thus spent electrolyte can be drained and the system can be refilled with new electrolyte. As such, a time-consuming recharging cycle can be avoided and a more time-efficient replenishing process can be undertaken for the electrolyte and/or electrodes. Any removed electrolyte and/or electrodes can be processed at a central facility for subsequent reuse.

1-31. (canceled)

32. A flow battery system comprising:
a first and second electrode, at least one of the first and second electrode comprising a lattice structure, wherein the lattice structure is a minimal surface type structure having portions that are arched in cross section so as to define concave and convex surfaces and that the lattice structure comprises a coating of a metal, a metal oxide or a conductive material;
at least one electrolyte supply configured to provide a flow of electrolyte through the at least one of the first and second electrodes to increase electron generation thereby generating high energy density; and
a power circuit operatively connected to the first and second electrodes to provide electrical power from the system.

33. The flow battery system according to claim 32, comprising a first reservoir for storing a charged electrolyte and a second reservoir for storing a discharged electrolyte, the first and second reservoir being fluidly separate, wherein each of the reservoirs comprises a respective inlet and outlet, each inlet and outlet comprising a valve to allow/prevent the flow of electrolyte therethrough.

34. The flow battery system according to claim 32, wherein:
at least one of the first and second electrode comprises a substantially planar panel,
at least one of the first and second electrode is provided in a housing, the housing comprising a plurality of the at least one of the first and second electrode, or
at least one of the first and second electrode are provided in a pressurised housing, and
wherein the panels are spaced in a direction perpendicular to the plane of the panel, or the panels are spaced in a direction perpendicular to the plane of the panel, and the panels are perpendicular to the flow the electrolyte; and
one or more of the electrodes are removable from the system.

35. The flow battery system according to claim 32, where each of the electrode from the first and second electrode comprises a plurality of porous sheets bonded at one or more point, wherein
at least one of the sheets comprises a 3-dimensional shape, and the 3-dimensional shape comprises a repeating, cyclic, oscillating form,
the 3-dimensional shape comprises a plurality of oscillations, the oscillations extending in a non-parallel direction to one another, and
the electrode comprises a 3-dimensional network of channels or pores.

36. The flow battery system according to claim 32, where the lattice structure comprises a conductive polymer that has a conductive material, and wherein the conductive material comprises graphene or graphite.

37. The flow battery system according to claim 32, where the coating comprises one or more: Lithium; Magnesium; Lead, Nickel; and/or oxides thereof.

38. A method of manufacturing the electrode selected from a first and second electrode of a flow battery system according to claim 32, comprising manufacturing the lattice structure using a 3D printing technique, and the 3D printing technique comprises one or more of: stereolithography; fused filament fabrication; or selective laser sintering.

39. A method manufacturing the electrode of claim 38, comprising:
providing a first porous sheet;
overlying the first sheet with a second porous sheet;
bonding the first sheet to the second sheet at one or more discrete location; and deforming one or both of sheets to provide a 3-dimensional structure.

40. The method according to claim 39, comprising:
separating the first and second sheet to cause deformation of the first and/or second sheet after bonding of the first and second sheet; and
deforming the first and/or second sheet prior to bonding of the first and second sheet, the bonding method comprises brazing, and the porosity of the first and/or second sheet is provided by a series or array of discontinuities therein.

41. A method of using a flow battery system of claim 32, comprising:
providing a charged electrolyte in a first reservoir;
discharging the charged electrolyte to provide electrical power, the discharged electrolyte is recharged at a site remote the flow battery system;
storing the discharged electrolyte in a second reservoir;
emptying the discharged electrolyte from the second reservoir;
replenishing the flow battery with charged electrolyte that is different from the discharged electrolyte.
